(19) United States
(12) Patent Application Publication
(10) Pub. No.: US 2026/0236340 A1
(43) Pub. Date: Aug. 13, 2026

(54) REFLECTION FRAMEWORKS FOR AGENT WORKFLOWS

(71) Applicant: International Business Machines Corporation, Armonk, NY (US)

(72) Inventors: Zhong Fang YUAN, Xi'an (CN); Tong LIU, Xi'an (CN); Wen WANG, Hai Dian District (CN); He LI, Beijing (CN); Raymond Lee Man Lee Man KONG, Shanghai (CN); Pan LI, Changping District (CN)

(21) Appl. No.: 19/053,414

(22) Filed: Feb. 13, 2025

(51) Int. Cl. G06F 11/07

(52) U.S. Cl. CPC G06F 11/0793; G06F 11/0715; G06F 11/0766

(57) ABSTRACT

In some implementations, one or more computing devices may generate a first layer of a hierarchical workflow. The one or more computing devices may generate a second layer of a hierarchical workflow configured to: receive a first output from the first layer as an indication of a first state of the first layer; provide an indication of an error associated with the first output; and receive a second output, as an indication of a second state of the first layer, from the first layer. The second output may be revised from the first output based at least in part on the indication of the error or the second output may be the same as the first output after correcting performance of one or more operations at the first layer.

### BACKGROUND

Agent workflows include a set of operations performed by a computing device and may include receiving an input and providing output information. For example, an artificial intelligence (AI) assistant or AI chatbot may receive a digital input from a user, process the input, access information associated with the input, and provide a digital output back to the user. An agent workflow may use a machine learning (ML) model, a database, a natural language processing tool, or a search engine, among other examples.

### SUMMARY

In some implementations, a method comprises generating a first layer of a hierarchical workflow and generating a second layer of a hierarchical workflow. The second layer of the hierarchical workflow is configured to receive a first output from the first layer as an indication of a first state of the first layer. The second layer of the hierarchical workflow is configured to provide an indication of an error associated with the first output, The second layer of the hierarchical workflow is configured to receive a second output, as an indication of a second state of the first layer, from the first layer. The second output is revised from the first output based at least in part on the indication of the error or the second output is the same as the first output after correcting performance of one or more operations at the first layer.

In some implementations, a computer program product comprises one or more computer readable storage media and program instructions collectively stored on the one or more computer readable storage media. The program instructions comprise program instructions to identify logical execution sequences of services of an agent workflow. The program instructions comprise program instructions to identify a first set of the services upon which a second set of services depend. The program instructions comprise program instructions to assign the first set of services to a first layer of the agent workflow. The program instructions comprise program instructions to assign the second set of services to a second layer of the agent workflow. The program instructions comprise program instructions to provide, from the first layer to the second layer, an indication of a state of the first layer in a computer-based language.

In some implementations, a system comprises one or more devices configured to generate a first layer of a hierarchical workflow comprising a first set of services of the hierarchical workflow. The one or more devices are configured to generate a second layer of a hierarchical workflow comprising a second set of services of the hierarchical workflow. The second set of services is dependent on one or more services of the first set of services. The one or more devices are configured to generate a third layer of a hierarchical workflow comprising a third set of services of the hierarchical workflow. The third set of services is dependent on one or more services of the second set of services. The first layer is configured to perform one or more operations associated with the first set of services based at least in part on an input and to provide an indication of a first state of the first layer to the second layer. The second layer is configured to perform one or more operations associated with the second set of services based at least in part on the first state of the first layer and provide an indication of a second state of the second layer to the third layer. The third layer is configured to perform one or more operations associated with the third set of services based at least in part on the second state of the second layer and provide an indication of a second state of the second layer to the third layer. Based at least in part on error detection at a layer of the hierarchical workflow, the system is configured to re-perform operations associated with the layer having the error without first re-performing operations associated with a previous layer.

### BRIEF DESCRIPTION OF THE DRAWINGS

FIGS. 1A-1B are diagrams of an example implementation described herein.

FIG. 2 is a diagram of an example implementation described herein.

FIGS. 3A-3B are diagrams of an example implementation described herein.

FIG. 4 is a diagram of an example computing environment in which systems and/or methods described herein may be implemented.

FIG. 5 is a diagram of example components of one or more devices of FIGS. 1-4.

FIGS. 6-8 are flowcharts of example processes associated with reflection frameworks for agent workflows.

### DETAILED DESCRIPTION

The following detailed description of example implementations refers to the accompanying drawings. The same reference numbers in different drawings may identify the same or similar elements.

A large language model (LLM) and agent workflow (agent) framework may achieve improved results relative to original LLM solutions. Agent design patterns may include reasoning and acting (ReAct), plan and execution, reflection, or multi-agent collaboration, among other examples. Under these agent design patterns, an LLM may generate a series of complex thoughts and call appropriate tools to complete a series of tasks.

However, results generated when completing complex tasks may be unstable or inconsistent. For example, the LLM may provide a different output even if the same prompt is provided. In some cases, the difference between outputs may be significant, or may be a simple rephrasing of the same meaning.

In existing agent design patterns, natural language serves as a carrier language for all information exchanges within the LLM. The advantage of using the natural language as the carrier language is that it allows humans to easily understand each operation performed by the LLM. However, this may cause problems associated with "synonym instability" and "long context information attenuation" of natural language. These two properties indicate that when LLM processes natural language, due to the randomness within the model, different outputs are produced for synonymous contexts. This instability may increase corresponding to increased length of the context received by the LLM. Additionally, when completing complex tasks, if an error occurs in any intermediate step, the task is restarted from the beginning.

In some aspects described herein, a computing device may perform an agent workflow using a reflection framework. The computing device may generate layers of a hierarchical workflow, including a first layer and a second layer. The layers may be configured with a set of finite states (e.g., 5 to 2,000 or more discrete states). The layers may be referred to as finite state machines. The first layer may be configured to perform one or more operations based at least in part on an input and may select a state of the first layer. The first layer may indicate the selected state to the second layer. The second layer may use the indication of the state of the first layer to perform additional operations at the second layer. In some aspects, the second layer may select a state of the second layer and indicate the state of the second layer to a third layer or provide a response to a user (e.g., via a computing device or application programming interface (API) associated with the user). In some aspects, the second layer may identify an error and provide feedback to the first layer that an error occurred (e.g., “reflection). The first layer may perform operations to select an alternative state of the first layer and provide an indication of the alternative state to the second layer. The second layer may then perform one or more operations based at least in part on the alternative state of the first layer and select a state of the second layer. In this way, the computing device may perform the agent workflow in a way that supports mid-stream correction (e.g., without restarting the entire workflow) and reduces computing and storage resources (e.g., based at least in part on the layers having finite states), among other benefits.

In some examples, the reflection framework described herein transforms an agent workflow from being driven by natural language (where natural language is used to communicate between operators in the agent workflow) to a hybrid framework combining natural language and finite state machines. In this hybrid framework, the agent workflow may be divided into multiple autonomous and independent processes that are interconnected by finite state machines. Each autonomous and independent process may be described as an independent agent, where an internal flow of task information is mediated by natural language. However, in the entire workflow (e.g., between layers, finite state machines, or independent agents), the flow of task information is carried by the states of the finite state machine.

Using finite state machines, the computing device may discretize a complex agent workflow, obtaining layer states during a control process. These states may be finite and closely related to the type and number of states in the agent workflow. Using finite states may reduce a likelihood of weakening a thinking ability of the agent workflow from the LLM in the independent processes, while stability and controllability of the finite state machines improve performance of the agent workflow. When an error occurs in a system process, the erroneous layer (e.g., node) can be accurately located, and the computing device may re-execute the erroneous layer (e.g., instead of restarting at the beginning of the entire process) without affecting the layers that did not encounter errors.

The computing device may generate a hierarchical workflow control diagram. For example, the computing device may analyze and simulate an existing workflow through LLM, divide the existing workflow into multiple layers (e.g., a “workflow layer”) with a logical execution order. The multiple layers may have a sequential succession relationship. The computing device may use a combination of LLM, planning, and reflection to divide and adjust the service layers until the layers are independently divided.

The computing device may use finite state machines (FSM) (e.g., within layers of the agent workflow) to provide workflow control. The computing device may convert the agentic workflow into multiple autonomous sub-flows and use the state of FSM for unified control. This may reduce instability and ambiguity of natural language as a message carrier and may improve execution stability of complex tasks. Additionally, the information load of natural language can be reduced (e.g., in a range of 50%-70%), which may reduce an information entropy in the information flow, improving efficiency and stability of task completion.

In some aspects, the computing device may use a reflection mechanism with a breakpoint restart. For example, the computing device may use a reflection mechanism to enable effective error handling and breakpoint restart when completing complex tasks, rather than starting from the beginning of the workflow upon detection of errors at a middle layer of the workflow. This may be enabled by having the layers that are independent or having finite states of the layers. This reflection mechanism combines planning and execution capabilities of LLM to further optimize the processing flow of complex tasks of the agent workflow.

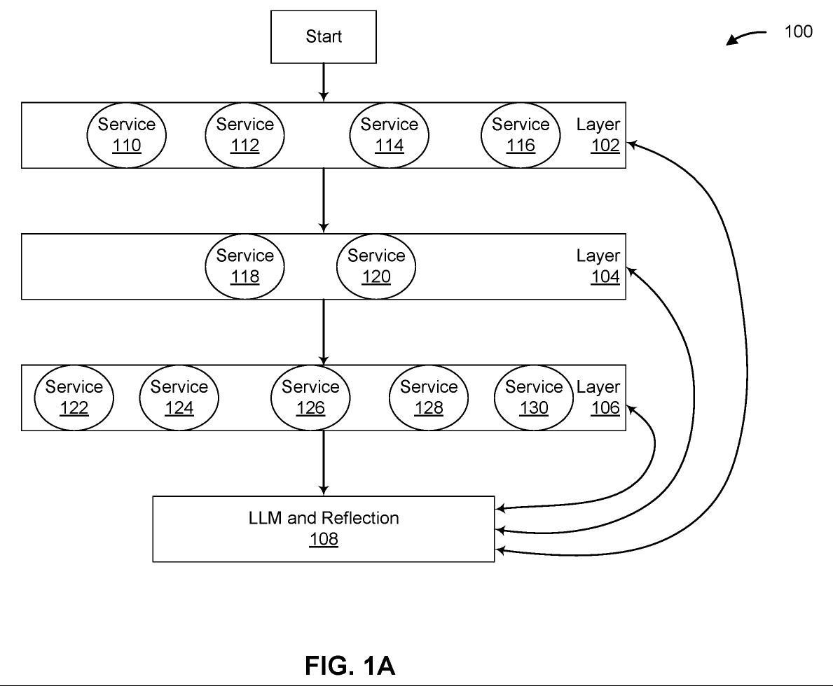

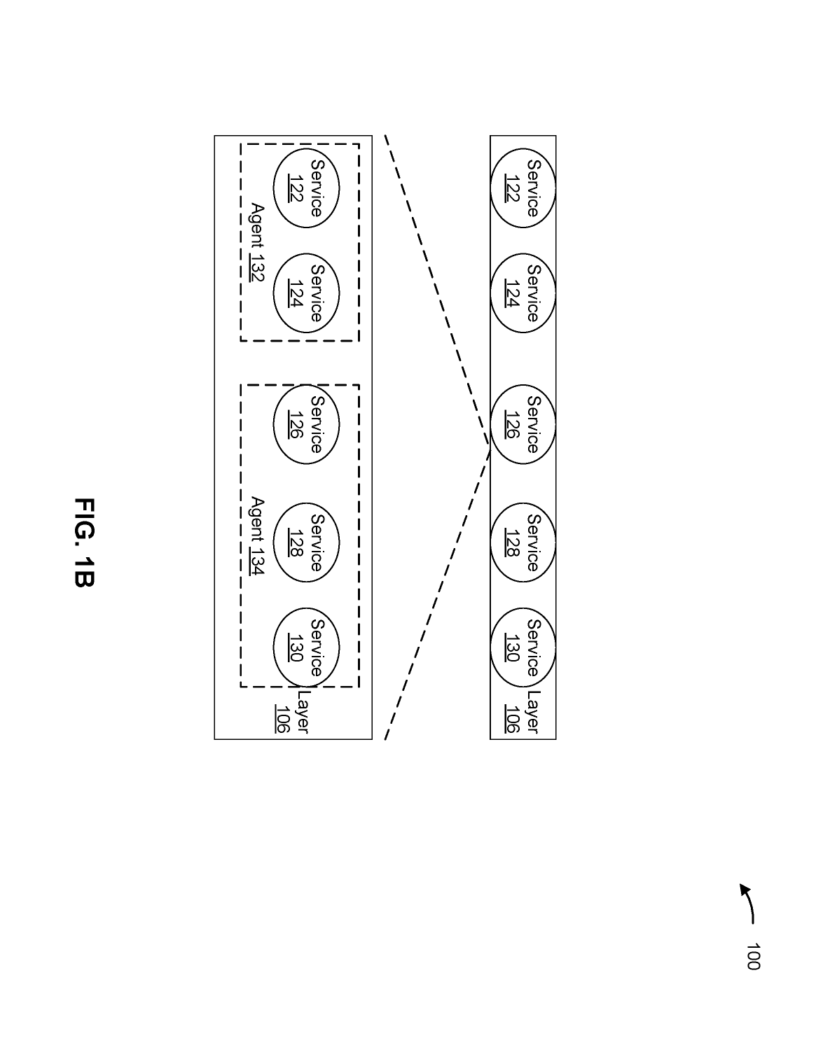

FIGS. 1A-1B are diagrams of an example implementation 100 described herein. As shown in FIGS. 1A-1B, example implementation 100 includes an agent workflow framework that may be executed or performed by one or more computing devices (e.g., computer 401 or device 500, among other examples). In some aspects, the agent workflow agent may implement one or more application programming interfaces (APIs), one or more artificial intelligence (AI) or machine learning (ML) models.

FIG. 1A shows an example implementation 100 showing a framework for an agent workflow. As shown in FIG. 1A, the framework may be divided into layers that are sequentially related. Layer 102 may include operations that are performed before operations of layer 104, which in turn includes operations that are performed before operations of layer 106. The framework may use an LLM and reflection 108 (e.g., a controller of the workflow) to convert natural language to computer-based language and to provide feedback to layers of the framework.

The one or more computing devices may generate the layered workflow control diagram from an original workflow. For example, the one or more computing devices may use the LLM to analyze and simulate the original workflow. The LLM and reflection 108 may divide the original workflow into multiple layers based at least in part on logical execution sequences (e.g., an ordered sequence of sets of operations). The logical execution sequences are used to assign services to different layers of the framework. In some aspects, there is a logical sequential relationship between each workflow-layer, where an input of workflow-layer_n comes (e.g., solely) from an output of workflow-layer_n-1, and an output of workflow-layer_n serves as an only input for workflow-layer_n+1.

Operations for dividing workflow layers may involve a combination of LLM, planning, and reflection. In some aspects, the operations may include converting (e.g., automatically) all service granular steps into natural language expressions. For example, the operations may include performing a model_qa(query) to answer common sense questions that are not real-time or do not require the latest time-sensitive information. The operations may include gs_qa(original_query, relevant_queries, local_file_id), which may be used to accept results generated by a kb_select function and generate a final answer based at least in part on the content. These queries may be answered in a same stage of the workflow framework rather than being answered one-by-one. The operations may include kb_select(original_query, relevant_queries) to automatically select a suitable knowledge base and split the original query into sub relevant queries for improved results. Original_query is the original question received from the user (e.g., a digital input) and relevant_queries is sub-questions (e.g., three or fewer) generated in association with the original question..

The one or more computing devices may use a planning methodology of LLM to hierarchically divide the services of the agent workflow framework. With the levels having sequential relationships the one agent workflow has been organized with a preliminary planning scheme. The one or more computing devices may using the LLM and reflection mechanism to adjust the preliminary planning scheme until the levels are completely independently divided. In some aspects, the one or more computing devices may use input from manual review to divide the levels of the agent workflow.

As shown in FIG. 1A, layers of the agent workflow may include one or more services. For example, layer 102 may include services 110, 112, 114, and 116 that are associated with operations that use input from a previous layer (or in this case, a starting input) to perform the operations. Layer 104 includes services 118 and 120 that use an output of the layer 102 (e.g., one state associated with the layer 102 or multiple states associated with different services of the layer 102) as an input to perform one or more operations. Outputs of the services 118 and 120 may be used to provide an output (e.g., a single layer state or states associated with services of layer 104) from layer 104 to layer 106. Services 122, 124, 116, 128, and 130 may use as inputs one or more components of the output from layer 104 to layer 106. For example, services 122, 124, 116, 128, and 130 may use a single layer state of layer 104 as an input to perform operations. In some aspects, one or more of the services 122, 124, 116, 128, and 130 may use one or more states of one or more of services 118 or 120 as inputs to perform operations.

As shown in FIG. 1B, services (e.g., services 122, 124, 116, 128, and 130) of a layer (e.g., layer 106) may be grouped as agents within the layer. For example, as shown in FIG. 1B, services 122 and 124 may be grouped as agent 132 and services 126, 128, and 130 may be grouped as agent 134 within layer 106. In some aspects, a service can be included in multiple agents (e.g., agents 122 and 124 may both include a service, such as service 126). The agents (e.g., agent 132 and 134, along with other agents of other layers) may be referred to as nodes or autonomous nodes.

In some aspects, the one or more computing devices may perform a splitting operation to group the services into agents. For example, the one or more computing devices may use a task combination matching method based at least in part on task descriptions associated with the services. The one or more computing devices may use LLM to perform logical link judgments based at least in part on the task descriptions of each service (e.g., previously defined). For example, the one or more computing devices may group services (e.g., functions) with logical correlations, that satisfy a threshold) into the agents (e.g., logical nodes). The one or more computing devices may register the services within these agents as tools in the logic of the agent, and these agents (e.g., logical nodes) may be automatically converted into a ReAct agent. These agents or logical nodes may serve as the smallest task units in future tasks associated with the agent workflow.

As described herein (e.g., in connection with FIGS. 1A-1B), the one or more computing devices may convert an original ReAct agent-based process into a layered workflow, with each layer containing multiple autonomous agents. Within their autonomous scopes, these agents be operate similarly to traditional ReAct agents. However, interactions between agents (e.g., including same-layer and cross-layer) may be controlled using a concept of finite state machines (FSM). In some aspects, each workflow layer may be associated with a state, and each agent within a layer can be associated with a sub-state.

In some aspects, the one or more computing devices may define workflow layers and states. The one or more computing devices may determine layers and corresponding states, with each workflow layer representing a state. For example, Layer 1 (Order Reception) with a “State: Order Received”. Layer 2 (Payment Processing) with a “State: Payment Processing.” Layer 3 (Order Fulfillment) with a “State: Order Fulfilled.” Layer 4 (Shipping) with a “State: Shipping.” Layer 5 (Completion) with a “State: Completed.” After defining all the states, the one or more computing devices may assign an initial state to the agent workflow (e.g., the system).

The one or more computing devices may divide sub-layers and agents in each layer. Within each state (associated with a layer), the agent workflow may include multiple autonomous agents, each of which can be seen as a sub-state responsible for carrying out specific tasks within that state. For example, an “Order Reception Layer” may include a “Verify Order Agent” and a “Create Order Record Agent.” A “Payment Processing Layer” may include a “Validate Payment Details Agent” and a “Process Payment Agent.” An “Order Fulfillment Layer” may include a “Check Inventory Agent” and a “Pack Items Agent.” A “Shipping Layer” may include a “Generate Shipping Label” Agent and a “Dispatch Package Agent.” In this example, each agent performs specific tasks within its associated layer, thereby contributing to progressive advancement of the full workflow.

In the example, a layer may provide an indication of a state of the layer once the layer satisfies a condition. For example, the workflow may be in a state of “Order Received.” Once the agents of the “Order Reception Layer” complete operations, the order may be verified and recorded. This event satisfies a condition for the “Order Reception Layer” to provide an indication of a state of “Payment Processing” to the “Payment Processing Layer.” One the agents of the “Payment Processing Layer” complete operations, the payment may be validated and processed. This event satisfies a condition for the “Payment Processing Layer” to provide an indication of a state of “Order Fulfilled” to the “Order Fulfillment Layer.” Agents of the “Order Fulfillment Layer” may perform operations to check inventory and pack the order. Completion of these operations satisfies a condition to provide an indication of a state of “Shipping” to the “Shipping Layer.” Agents of the “Shipping Layer” may perform operations to generate a shipping label and dispatch the package of the order. Completion of these operations satisfies a condition to provide an indication of a state of “Completed” to a user or other system.

In some aspects, the indications of the states from one layer to the next layer may be in a computer language (e.g., analog signaling or digital signaling) rather than in natural language.

As indicated above, FIGS. 1A-1B are provided as an example. Other examples may differ from what is described with regard to FIGS. 1A-1B. For example, the number and arrangement of layers and services shown in FIGS. 1A-1B may differ in application to other example workflow agents.

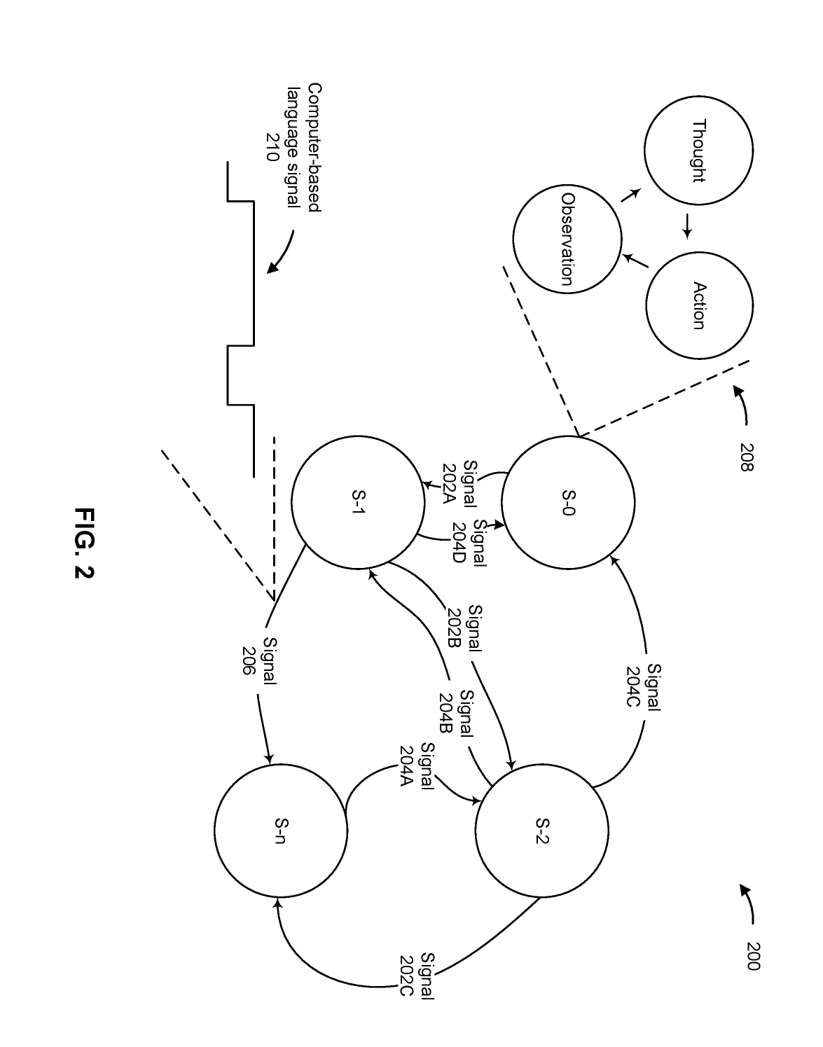

FIG. 2 is a diagram of an example implementation 200 described herein. As shown in FIG. 2, example implementation 200 includes an agent workflow framework that may be executed or performed by one or more computing devices (e.g., computer 401 or device 500, among other examples). In some aspects, the agent workflow agent may implement one or more application programming interfaces (APIs), one or more artificial intelligence (AI) or machine learning (ML) models.

As shown in FIG. 2, the agent workflow framework may include services 0 (S-0), 1 (S-1), 2 (S-2), and n (S-n). As described in connection with FIG. 2, services 0, 1, 2, and n may be organized into agents and layers of agents.

As shown in FIG. 2, service 0 may provide a downstream signal 202A to service 1. Service 1 may provide a downstream signal 202B to service 2. Service 2 may provide a downstream signal 202C to service n. In some aspects, the service n may provide an upstream signal 204A to service 2. Service 2 may provide an upstream signal 204B to service 1 or may provide an upstream signal 204C to service 0. Service 1 may provide an upstream signal 204D to service 0 or may provide a downstream signal 206 to Service n. In some aspects, services of FIG. 2 may be on a same layer, and signals between services on a same layer may be same-stream signals rather than upstream signals or downstream signals. In some aspects, the signals 202A-206 may include a computer-based language signal 210 (e.g., an analog or digital signal rather than natural language).

In some aspects, one or more of the services may include operations 208, such as thought, action, and observation. Using these operations 208, a service may perform an autonomous operation (e.g., an independent agent operation that include operations 208) using input data to produce an output. In some aspects, the service may use natural language to move information between the operations within the service. In this way, the service may operate similar to a ReAct model.

In some aspects, the services may provide an upstream signal based at least in part on identifying an error in a downstream service (e.g., a service on a lower layer). In some aspects, the upstream signal may be sent to only one relevant service on an upstream layer, to multiple services on an upstream layer (e.g., all services of the upstream layer or all services of an agent of the upstream layer), or to multiple upstream layers.

In some aspects, the layers and sub-layers (e.g., agents or services of a layer) may coordinate work with other layers and sub-layers (e.g., the one or more computing devices may coordinate between the layers and sub-layers). In some aspects, agents of a layer may coordinate so that all agents within each layer complete their sub-tasks at each state. In some aspects, the layers may coordinate to trigger corresponding sub-layer state transitions after each agent completes its task.

The one or more computing devices associated with the agent workflow framework may manage sub-layers within layers. For example, the one or more computing devices may monitor and manage states of sub-layers (e.g., agents) at each state to support completion of sub-layer tasks in sequence.

In some aspects, the one or more computing devices may perform integration of state signals flow. For example, the one or more computing devices may define signal transmission mechanisms to coordinate between layers using state transition signals. The one or more computing devices may define signal transmission mechanisms to coordinate internally within sub-layers (e.g., agents) using task completion signals.

In some aspects, the one or more computing devices may support a smooth and accurate signal flow. For example, within each layer, the one or more computing devices may support timely transmission of signals after each agent completes its task. Between layers, the one or more computing devices may support effective triggering the start of a subsequent state upon detection of state transition signals.

As indicated above, FIG. 2 is provided as an example. Other examples may differ from what is described with regard to FIG. 2. For example, the number and arrangement of layers and services shown in FIG. 2 may differ in application to other example workflow agents.

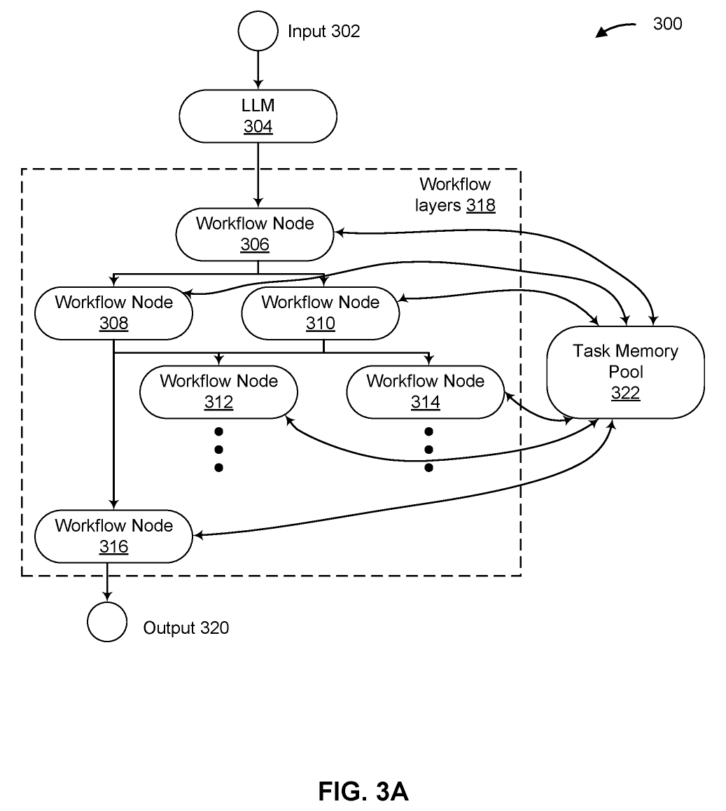

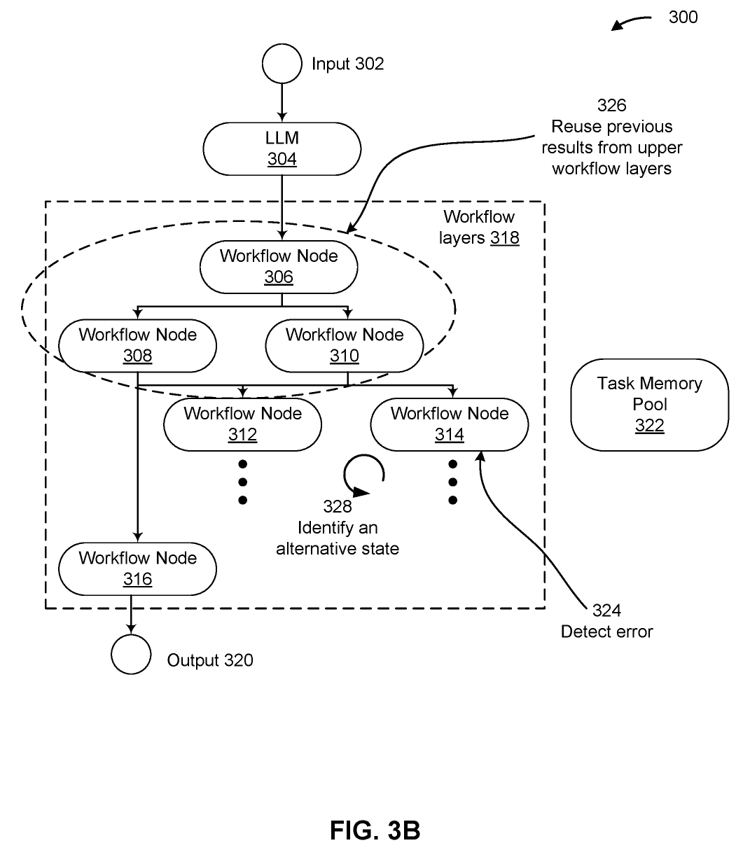

FIGS. 3A-3B are diagrams of an example implementation 300 described herein. As shown in FIGS. 3A-3B, example implementation 300 includes an agent workflow framework that may be executed or performed by one or more computing devices (e.g., computer 401 or device 500, among other examples). In some aspects, the agent workflow agent may implement one or more application programming interfaces (APIs), one or more artificial intelligence (AI) or machine learning (ML) models.

As shown in FIGS. 3A and 3B, the agent workflow framework may receive an input 302 to in LLM 304. The LLM may perform language processing to determine a request from the input 302 or tasks to be performed in association with reception of the input 302. The agent workflow framework may provide a signal from the LLM 304 to a workflow node 306 (e.g., an agent). The workflow node 306 may be configured as part of a first layer of the agent workflow framework. The workflow node 306 may perform one or more operations based at least in part on the output of the LLM 304. The workflow node 306 may provide an output to workflow nodes 308 and 310. The workflow nodes 308 and 310 may be configured as part of a second layer of the agent workflow framework. The workflow nodes 308 and 310 (e.g., sub-layers of the second layer of the workflow) may provide outputs to one or more workflow nodes of a subsequent layer (e.g., workflow nodes 312, 314 and 316). In some aspects, one or more additional workflow nodes or layers may be included in the workflow layers 318 in addition to workflow nodes 306-316. After performance of operations by the workflow nodes, the workflow layers 318 may provide an output 320.

In some aspects, the workflow nodes 306-316 may communicate via computer-based language rather than natural language. In some aspects, the communications may indicate a state of sending workflow node or associated layer.

In some aspects, the workflow nodes 306-316 may provide information to a task memory pool 322. The task memory pool 322 may provide private memory space to autonomous agents. In some aspects, each autonomous agent may have dedicated private memory space that stores task records within the scope of that agent (e.g., in a graph structure primarily using natural language). The graph structure may support relationships and dependencies between tasks to be established, which may support a coherent memory network. Each workflow node represents a task of the agent workflow framework. The connecting lines represent relationships between tasks. This may support the organization of the agent framework into layers and agents, as described herein. In some aspects, task records may be processed into graph vectors to facilitate quick retrieval and processing.

In some aspects, the task memory pool 322 may include a public memory space (e.g., shared across two or more, or all, workflow layers 318) for task states and querying and tracking task records. For example, the full agent workflow framework may share a public memory space based at least in part on task states. The public memory space may store structured task records, including tabular data such as upstream workflow node lists, task types, downstream workflow node lists, or task output compositions, among other examples. The formalized storage of tabular data may support efficient and accurate querying and tracking of tasks. Through queries, information such as all involved autonomous agents, an agent execution sequence, intermediate results, etc., may be retrieved. The querying mechanism may utilize graph database technology to ensure rapid retrieval of relevant data, enhancing overall system efficiency.

In some aspects, the task memory pool 322 may handle states in a finite-state machine (FSM) system of the agent workflow. The tabular data may be processed into states within the FSM. Each state represents a specific task state, and the FSM may achieve ordered task execution and error localization (e.g., identification of an error at a service, agent, or workflow, rather than at the full agent workflow) through state transition mechanisms.

The definition of a state may include entry conditions that define when and under what conditions a task can enter the current state. For example, certain tasks may be completed or specific conditions satisfied before reaching the current state. The definition of the state may include execution actions that describe operations that are to be performed in the current state. These operations may include data processing, decision tree traversal, or other computational tasks, among other examples. In some aspects, the execution actions may include a relatively small number of tasks or a relatively large number of tasks. In some aspects, some states are associated with a relatively small number of tasks and other states are associated with a relatively large number of tasks. In this way, agents or workflow layers may support scalability and flexibility to accommodate requirements of different types of tasks. The definition of the states may include exit conditions that determine when and under what conditions a task can transition from the current state to the next state. These conditions may be based at least in part on results of execution actions or triggers from other external events. The agent workflow may use the state definitions, to effectively manage the flow of tasks, supporting execution of tasks as expected, and reducing a likelihood of deadlocks and conflicts among services. In some aspects, using FSMs supports dynamic adjustments, such as updating states and conditions in real-time during task execution to adapt to changing task requirements and environments.

In some aspects, the one or more computing devices may perform optimization and maintenance on the task memory pool 322. For example, to support efficient operation of the task memory pool 322, the one or more computing devices (e.g., a “system”) may regularly optimize and maintain memory data. Optimization processes may include cleaning up redundant data, compressing data, or rebuilding indexes, among other examples. During maintenance, the system may dynamically adjust the graph structure based at least in part on a task execution history to support a real-time and an accurate nature of memory data. Through these mechanisms, the task memory pool 322 (e.g., a FSM-state-based memory pool module) enhances the stability and reliability of task execution and may also provide flexible and efficient support for the decomposition and execution of complex tasks.

As shown in FIG. 3B, and by reference number 324, the system (e.g., one or more computing devices) may detect an error associated with one of the workflow nodes (e.g., shown as workflow node 314). In some aspects, the system may detect the error based at least in part on failure of a downstream agent or service that uses an output from the erroneous workflow node.

As shown by reference number 326, the system may reuse previous results from upper workflow layers (e.g., workflow layers that are previous to, or above, the erroneous workflow node). In some aspects, the system may reuse the previous results from upper workflow layers based at least in part on using a FSM-based agent workflow and having state information stored at the task memory pool 322. This may conserve resources, improve latency, and improve efficiency relative to other agent workflows that use natural language-based communications between services, where the system would start from the beginning of the agent workflow if an error is detected.

As shown by reference number 328, workflow node 314 may identify an alternative state based at least in part on an input provided by reusing previous results from the upper workflow layers. The workflow node 314 may provide the alternative state to a downstream workflow node instead of an erroneous state, as detected in connection with reference number 324. As described above, the workflow node 314 may identify the alternative state without all of the upstream workflow nodes repeating operations previously performed. Although shown as reusing previous results from workflow nodes 306, 308, and 310, in some aspects, one or more of workflow node 308 or workflow node 310 may perform an associated operation to generate an alternative result, or to confirm a previous result, to provide to workflow node 314 as an input.

The task memory pool 322 may be used to support reusing previous results from the upper workflow layers. For example, the task memory pool 322 may have structured work logs and related information indexes in a public memory space, which may include tabular data for each task. The tabular data may include upstream node lists, task types, downstream node lists, or task output compositions, among other examples. When a task encounters an issue (e.g., error), a location of the issue may be quickly and accurately based at least in part on associated with one or more autonomous agents that are affected through simple retrieval methods. Leveraging this structured data allows preserving task results up to the point of failure without unnecessarily performing the previous operations (e.g., associated with upper workflow layers). The supports a direct restart from the identified autonomous agents associated with the error. This approach reduces reruns of the entire task chain and focuses on correcting only a problematic part, thus enhancing efficiency and reducing consumption of resources.

Additionally, memories in the private memory space may be stored as graph vectors. Task records within each autonomous agent may form a graph structure. Through attention mechanisms, the system may identify precise matches and pinpoint internal issues within the autonomous agents. The attention mechanism may identify key workflow nodes and connections (e.g., arrows in FIGS. 3A-3B) in a complex memory network to identify specific locations of errors. For detected issues, the system may provide detailed prompts for reevaluation (e.g., to modify performance of one or more operations or to change a state), which may guide autonomous agents on error correction and task continuation. In this way, the system may swiftly locate problems and also guides autonomous agents toward self-improvement, enhancing self-repair capabilities of the agents.

Through these mechanisms, the agent workflow may use checkpoint restarts while maintaining autonomy of the agents within the agent workflow. In this way, upon encountering issues during task execution, the system can restart from the last correct results of agents while avoiding the previous errors, thereby saving significant time and resources. This approach may improve task success rates and overall efficiency.

By combining the advantages of public and private memory spaces, reflection mechanisms, and checkpoint restarts, the reliability of the agent workflow and autonomy agents may be improved. The public memory space may provide global task state management and fault localization, while the private memory space may offers fine-grained error detection and correction within autonomous agents. Through this integrated mechanism, autonomous agents can efficiently tackle various challenges, swiftly recover, and continue task completion, supporting system stability and continuous improvement capability.

As indicated above, FIGS. 3A-3B are provided as an example. Other examples may differ from what is described with regard to FIGS. 3A-3B. The number and arrangement of devices shown in FIGS. 3A-3B are provided as an example.

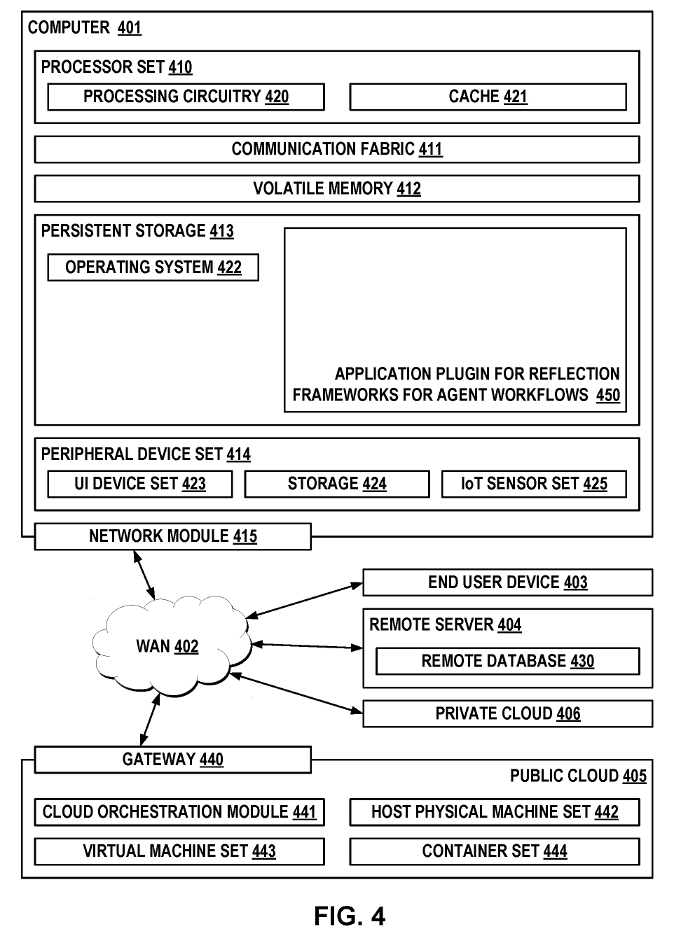

FIG. 4 is a diagram of an example computing environment 400 in which systems and/or methods described herein may be implemented. Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment ("CPP embodiment" or “CPP”) is a term used in the present disclosure to describe any set of one, or more, storage media (also called "mediums") collectively included in a set of one, or more, storage devices that collectively include machine readable code corresponding to instructions and/or data for performing computer operations specified in a given CPP claim. A "storage device" is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 400 contains an example of an environment for the execution of at least some of the computer code involved in performing the inventive methods, such as application plugin for reflection frameworks for agent workflows 450. In addition to application plugin for reflection frameworks for agent workflows 450, computing environment 400 includes, for example, computer 401, wide area network (WAN) 402, end user device (EUD) 403, remote server 404, public cloud 405, and private cloud 406. In this embodiment, computer 401 includes processor set 410 (including processing circuitry 420 and cache 421), communication fabric 411, volatile memory 412, persistent storage 413 (including operating system 422 and application plugin for reflection frameworks for agent workflows 450, as identified above), peripheral device set 414 (including user interface (UI) device set 423, storage 424, and Internet of Things (IoT) sensor set 425), and network module 415. Remote server 404 includes remote database 430. Public cloud 405 includes gateway 440, cloud orchestration module 441, host physical machine set 442, virtual machine set 443, and container set 444.

Computer 401 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 430. As is well understood in the art of computer technology, and depending upon the technology, performance of a computer-implemented method may be distributed among multiple computers and/or between multiple locations. On the other hand, in this presentation of computing environment 400, detailed discussion is focused on a single computer, specifically computer 401, to keep the presentation as simple as possible. Computer 401 may be located in a cloud, even though it is not shown in a cloud in FIG. 4. On the other hand, computer 401 is not required to be in a cloud except to any extent as may be affirmatively indicated.

Processor set 410 includes one, or more, computer processors of any type now known or to be developed in the future. Processing circuitry 420 may be distributed over multiple packages, for example, multiple, coordinated integrated circuit chips. Processing circuitry 420 may implement multiple processor threads and/or multiple processor cores. Cache 421 is memory that is located in the processor chip package(s) and is typically used for data or code that should be available for rapid access by the threads or cores running on processor set 410. Cache memories are typically organized into multiple levels depending upon relative proximity to the processing circuitry. Alternatively, some, or all, of the cache for the processor set may be located “off chip.” In some computing environments, processor set 410 may be designed for working with qubits and performing quantum computing.

Computer readable program instructions are typically loaded onto computer 401 to cause a series of operational steps to be performed by processor set 410 of computer 401 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 421 and the other storage media discussed below. The program instructions, and associated data, are accessed by processor set 410 to control and direct performance of the inventive methods. In computing environment 400, at least some of the instructions for performing the inventive methods may be stored in application plugin for reflection frameworks for agent workflows 450 in persistent storage 413.

Communication fabric 411 is the signal conduction path that allows the various components of computer 401 to communicate with each other. Typically, this fabric is made of switches and electrically conductive paths, such as the switches and electrically conductive paths that make up busses, bridges, physical input / output ports and the like. Other types of signal communication paths may be used, such as fiber optic communication paths and/or wireless communication paths.

Volatile memory 412 is any type of volatile memory now known or to be developed in the future. Examples include dynamic type random access memory (RAM) or static type RAM. Typically, volatile memory 412 is characterized by random access, but this is not required unless affirmatively indicated. In computer 401, the volatile memory 412 is located in a single package and is internal to computer 401, but, alternatively or additionally, the volatile memory may be distributed over multiple packages and/or located externally with respect to computer 401.

Persistent storage 413 is any form of non-volatile storage for computers that is now known or to be developed in the future. The non-volatility of this storage means that the stored data is maintained regardless of whether power is being supplied to computer 401 and/or directly to persistent storage 413. Persistent storage 413 may be a read only memory (ROM), but typically at least a portion of the persistent storage allows writing of data, deletion of data and re-writing of data. Some familiar forms of persistent storage include magnetic disks and solid state storage devices. Operating system 422 may take several forms, such as various known proprietary operating systems or open source Portable Operating System Interface-type operating systems that employ a kernel. The code included in application plugin for reflection frameworks for agent workflows 450 typically includes at least some of the computer code involved in performing the inventive methods.

Peripheral device set 414 includes the set of peripheral devices of computer 401. Data communication connections between the peripheral devices and the other components of computer 401 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 423 may include components such as a display screen, speaker, microphone, wearable devices (such as goggles and smart watches), keyboard, mouse, printer, touchpad, game controllers, and haptic devices. Storage 424 is external storage, such as an external hard drive, or insertable storage, such as an SD card. Storage 424 may be persistent and/or volatile. In some embodiments, storage 424 may take the form of a quantum computing storage device for storing data in the form of qubits. In embodiments where computer 401 is required to have a large amount of storage (for example, where computer 401 locally stores and manages a large database) then this storage may be provided by peripheral storage devices designed for storing very large amounts of data, such as a storage area network (SAN) that is shared by multiple, geographically distributed computers. IoT sensor set 425 is made up of sensors that can be used in Internet of Things applications. For example, one sensor may be a thermometer and another sensor may be a motion detector.

Network module 415 is the collection of computer software, hardware, and firmware that allows computer 401 to communicate with other computers through WAN 402. Network module 415 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 415 are performed on the same physical hardware device. In other embodiments (for example, embodiments that utilize software-defined networking (SDN)), the control functions and the forwarding functions of network module 415 are performed on physically separate devices, such that the control functions manage several different network hardware devices. Computer readable program instructions for performing the inventive methods can typically be downloaded to computer 401 from an external computer or external storage device through a network adapter card or network interface included in network module 415.

WAN 402 is any wide area network (for example, the internet) capable of communicating computer data over non-local distances by any technology for communicating computer data, now known or to be developed in the future. In some embodiments, the WAN 402 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 403 is any computer system that is used and controlled by an end user (for example, a customer of an enterprise that operates computer 401) and may take any of the forms discussed above in connection with computer 401. EUD 403 typically receives helpful and useful data from the operations of computer 401. For example, in a hypothetical case where computer 401 is designed to provide a recommendation to an end user, this recommendation would typically be communicated from network module 415 of computer 401 through WAN 402 to EUD 403. In this way, EUD 403 can display, or otherwise present, the recommendation to an end user. In some embodiments, EUD 403 may be a client device, such as thin client, heavy client, mainframe computer, desktop computer and so on.

Remote server 404 is any computer system that serves at least some data and/or functionality to computer 401. Remote server 404 may be controlled and used by the same entity that operates computer 401. Remote server 404 represents the machine(s) that collect and store helpful and useful data for use by other computers, such as computer 401. For example, in a hypothetical case where computer 401 is designed and programmed to provide a recommendation based on historical data, then this historical data may be provided to computer 401 from remote database 430 of remote server 404.

Public cloud 405 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 405 is performed by the computer hardware and/or software of cloud orchestration module 441. The computing resources provided by public cloud 405 are typically implemented by virtual computing environments that run on various computers making up the computers of host physical machine set 442, which is the universe of physical computers in and/or available to public cloud 405. The virtual computing environments (VCEs) typically take the form of virtual machines from virtual machine set 443 and/or containers from container set 444. It is understood that these VCEs may be stored as images and may be transferred among and between the various physical machine hosts, either as images or after instantiation of the VCE. Cloud orchestration module 441 manages the transfer and storage of images, deploys new instantiations of VCEs and manages active instantiations of VCE deployments. Gateway 440 is the collection of computer software, hardware, and firmware that allows public cloud 405 to communicate through WAN 402.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 406 is similar to public cloud 405, except that the computing resources are only available for use by a single enterprise. While private cloud 406 is depicted as being in communication with WAN 402, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 405 and private cloud 406 are both part of a larger hybrid cloud.

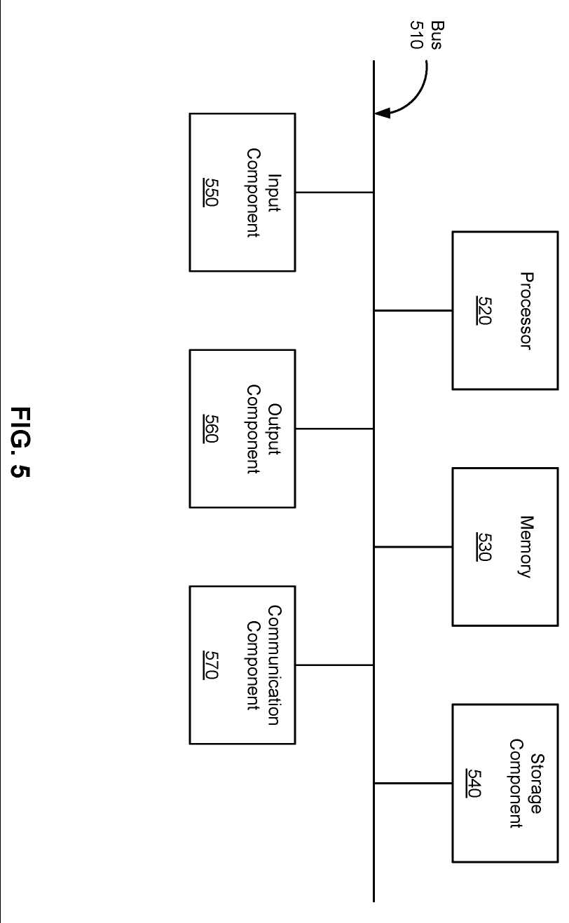

FIG. 5 is a diagram of example components of a device 500, which may correspond to the computing computer 401, among other examples, that performs agent workflow operations. In some implementations, the computer 401 may include one or more devices 500 and/or one or more components of device 500. As shown in FIG. 5, device 500 may include a bus 510, a processor 520, a memory 530, a storage component 540, an input component 550, an output component 560, and a communication component 570.

Bus 510 includes a component that enables wired and/or wireless communication among the components of device 500. Processor 520 includes a central processing unit, a graphics processing unit, a microprocessor, a controller, a microcontroller, a digital signal processor, a field-programmable gate array, an application-specific integrated circuit, and/or another type of processing component. Processor 520 is implemented in hardware, firmware, or a combination of hardware and software. In some implementations, processor 520 includes one or more processors capable of being programmed to perform a function. Memory 530 includes a random access memory, a read only memory, and/or another type of memory (e.g., a flash memory, a magnetic memory, and/or an optical memory).

Storage component 540 stores information and/or software related to the operation of device 500. For example, storage component 540 may include a hard disk drive, a magnetic disk drive, an optical disk drive, a solid state disk drive, a compact disc, a digital versatile disc, and/or another type of non-transitory computer-readable medium. Input component 550 enables device 500 to receive input, such as user input and/or sensed inputs. For example, input component 550 may include a touch screen, a keyboard, a keypad, a mouse, a button, a microphone, a switch, a sensor, a global positioning system component, an accelerometer, a gyroscope, and/or an actuator. Output component 560 enables device 500 to provide output, such as via a display, a speaker, and/or one or more light-emitting diodes. Communication component 570 enables device 500 to communicate with other devices, such as via a wired connection and/or a wireless connection. For example, communication component 570 may include a receiver, a transmitter, a transceiver, a modem, a network interface card, and/or an antenna.

Device 500 may perform one or more processes described herein. For example, a non-transitory computer-readable medium (e.g., memory 530 and/or storage component 540) may be a repository that stores a set of instructions (e.g., one or more instructions, code, software code, and/or program code) for execution by processor 520. Processor 520 may execute the set of instructions to perform one or more processes described herein. In some implementations, execution of the set of instructions, by one or more processors 520, causes the one or more processors 520 and/or the device 500 to perform one or more processes described herein. In some implementations, hardwired circuitry may be used instead of or in combination with the instructions to perform one or more processes described herein. Thus, implementations described herein are not limited to any specific combination of hardware circuitry and software.

The number and arrangement of components shown in FIG. 5 are provided as an example. Device 500 may include additional components, fewer components, different components, or differently arranged components than those shown in FIG. 5. Additionally, or alternatively, a set of components (e.g., one or more components) of device 500 may perform one or more functions described as being performed by another set of components of device 500.

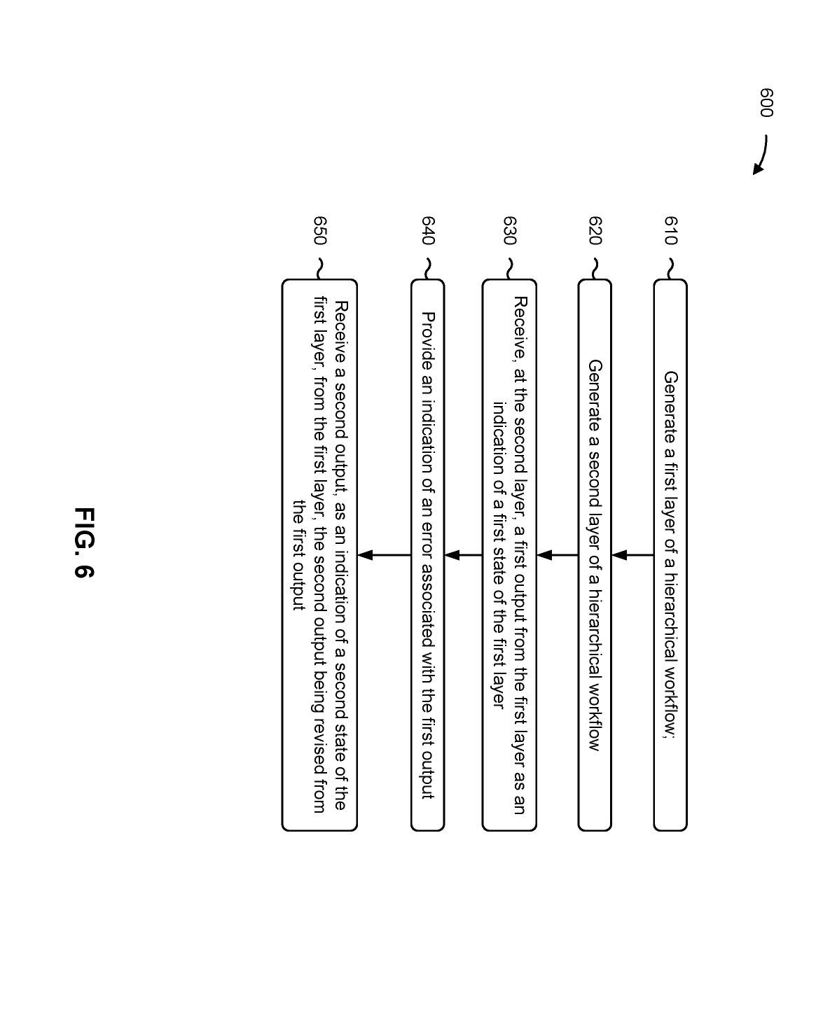

FIG. 6 is a flowchart of an example process 600 associated with reflection frameworks for agent workflows. In some implementations, one or more process blocks of FIG. 6 may be performed by one or more computing devices (e.g., computer 401). In some implementations, one or more process blocks of FIG. 6 may be performed by another device or a group of devices separate from or including the computing device, such as a network computing device, an application server, or a personal computing device. Additionally, or alternatively, one or more process blocks of FIG. 6 may be performed by one or more components of device 500, such as processor 520, memory 530, storage component 540, input component 550, output component 560, and/or communication component 570.

As shown in FIG. 6, process 600 may include generating a first layer of a hierarchical workflow (block 610). For example, the system of one or more computing devices may generate a first layer of a hierarchical workflow;, as described above.

As further shown in FIG. 6, process 600 may include generating a second layer of a hierarchical workflow (block 620). For example, the system of one or more computing devices may generate a second layer of a hierarchical workflow, as described above.

As further shown in FIG. 6, process 600 may include receiving a first output from the first layer as an indication of a first state of the first layer (block 630). For example, the system of one or more computing devices may receive a first output from the first layer as an indication of a first state of the first layer, as described above.

As further shown in FIG. 6, process 600 may include providing an indication of an error associated with the first output (block 640). For example, the system of one or more computing devices may provide an indication of an error associated with the first output, as described above.

As further shown in FIG. 6, process 600 may include receiving a second output, as an indication of a second state of the first layer, from the first layer, the second output being revised from the first output (block 650). For example, the system of one or more computing devices may receive a second output, as an indication of a second state of the first layer, from the first layer, as described above. The second output may be revised from the first output based at least in part on the indication of the error or the second output may be the same as the first output after correcting performance of one or more operations at the first layer.

Process 600 may include additional implementations, such as any single implementation or any combination of implementations described below and/or in connection with one or more other processes described elsewhere herein.

In a first implementation, the first state is selected from a finite quantity of selectable states.

In a second implementation, alone or in combination with the first implementation, generating the first layer of the hierarchical workflow and the second layer of the hierarchical workflow comprises identifying a first set of services of the hierarchical workflow, identifying a second set of services of the hierarchical that are dependent on at least one of the first set of services, assigning the first set of services to the first layer, and assigning the second set of services to the second layer.

In a third implementation, alone or in combination with one or more of the first and second implementations, the first set of services are not dependent on the second set of services.

In a fourth implementation, alone or in combination with one or more of the first through third implementations, process 600 includes grouping one or more first services of the first set of services into a first agent of the first layer, grouping one or more second services of the first set of services into a second agent of the first layer, grouping one or more third services of the second set of services into a third agent of the second layer, wherein agents are configured as independent logical nodes that can perform discrete operations and can be independently identified for errors.

In a fifth implementation, alone or in combination with one or more of the first through fourth implementations, process 600 includes performing a large language model operation, planning, and reflection to perform the groupings.

In a sixth implementation, alone or in combination with one or more of the first through fifth implementations, process 600 includes performing a large language model operation, planning, and reflections to assign the first set of services to the first layer and to assign the second set of services to the second layer.

In a seventh implementation, alone or in combination with one or more of the first through sixth implementations, the first layer of the hierarchical workflow is configured to provide an indication of the first state to a task memory pool, a previous layer of the hierarchical workflow is configured to provide an indication of a third state, associated with a state of the previous layer to the task memory pool, and the first layer is configured to receive the indication of the third state as an input to correct performance of the one or more operations of the first layer or provide the second output.

In an eighth implementation, alone or in combination with one or more of the first through seventh implementations, receiving the second output from the first layer comprises receiving the second output from the first layer without performing operations at the previous layer after providing the indication of the error associated with the first output.

In a ninth implementation, alone or in combination with one or more of the first through eighth implementations, receiving the first output and receiving the second output comprises receiving the first output and the second output in a computer-based language.

Although FIG. 6 shows example blocks of process 600, in some implementations, process 600 may include additional blocks, fewer blocks, different blocks, or differently arranged blocks than those depicted in FIG. 6. Additionally, or alternatively, two or more of the blocks of process 600 may be performed in parallel.

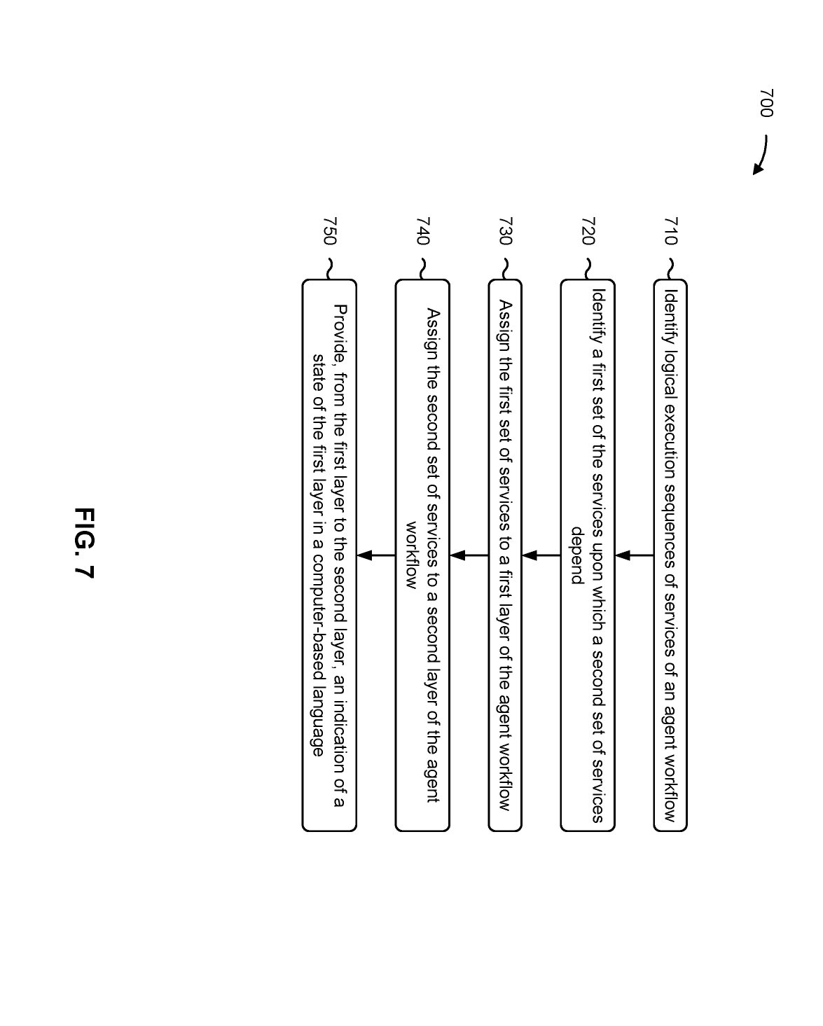

FIG. 7 is a flowchart of an example process 700 associated with reflection frameworks for agent workflows. In some implementations, one or more process blocks of FIG. 7 may be performed by one or more computing devices (e.g., computer 401). In some implementations, one or more process blocks of FIG. 7 may be performed by another device or a group of devices separate from or including the computing device, such as a network computing device, an application server, or a personal computing device. Additionally, or alternatively, one or more process blocks of FIG. 7 may be performed by one or more components of device 500, such as processor 520, memory 530, storage component 540, input component 550, output component 560, and/or communication component 570.

As shown in FIG. 7, process 700 may include identifying logical execution sequences of services of an agent workflow (block 710). For example, the system of one or more computing devices may identify logical execution sequences of services of an agent workflow, as described above.

As further shown in FIG. 7, process 700 may include identifying a first set of the services upon which a second set of services depend (block 720). For example, the system of one or more computing devices may identify a first set of the services upon which a second set of services depend, as described above.

As further shown in FIG. 7, process 700 may include assigning the first set of services to a first layer of the agent workflow (block 730). For example, the system of one or more computing devices may assign the first set of services to a first layer of the agent workflow, as described above.

As further shown in FIG. 7, process 700 may include assigning the second set of services to a second layer of the agent workflow (block 740). For example, the system of one or more computing devices may assign the second set of services to a second layer of the agent workflow, as described above.

As further shown in FIG. 7, process 700 may include providing, from the first layer to the second layer, an indication of a state of the first layer in a computer-based language (block 750). For example, the system of one or more computing devices may provide, from the first layer to the second layer, an indication of a state of the first layer in a computer-based language, as described above.

Process 700 may include additional implementations, such as any single implementation or any combination of implementations described below and/or in connection with one or more other processes described elsewhere herein.

In a first implementation, providing the indication of the state of the first layer in the computer-based language comprises refraining from providing the indication of the state of the first layer in natural language.

In a second implementation, alone or in combination with the first implementation, the program instructions comprise program instructions to group the first set of services into one or more first independent agents of the agent workflow, program instructions to group the second set of services into one or more second independent agents of the agent workflow, and program instructions to identify errors within the agent workflow at an agent granularity.

In a third implementation, alone or in combination with one or more of the first and second implementations, process 700 includes program instructions to use a large language model, planning, and reflection to perform an initial identification of the first set of services and to revise the first set of services.

Although FIG. 7 shows example blocks of process 700, in some implementations, process 700 may include additional blocks, fewer blocks, different blocks, or differently arranged blocks than those depicted in FIG. 7. Additionally, or alternatively, two or more of the blocks of process 700 may be performed in parallel.

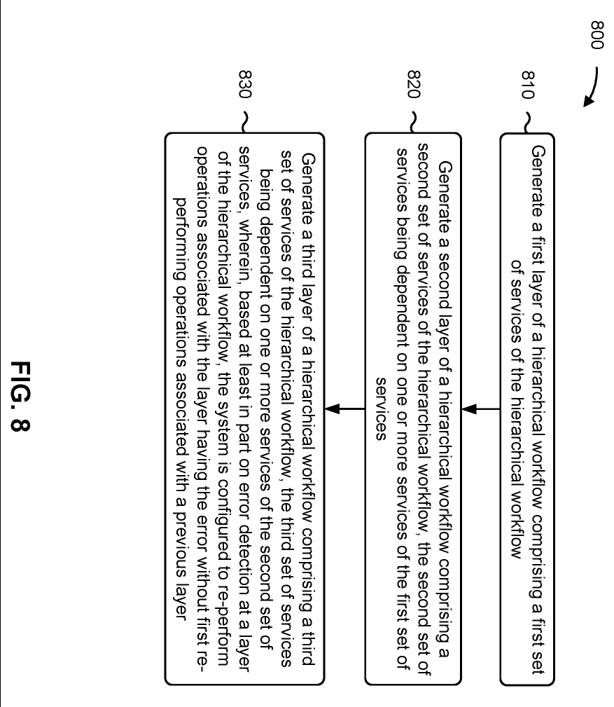

FIG. 8 is a flowchart of an example process 800 associated with reflection frameworks for agent workflows. In some implementations, one or more process blocks of FIG. 8 may be performed by one or more computing devices (e.g., computer 401). In some implementations, one or more process blocks of FIG. 8 may be performed by another device or a group of devices separate from or including the computing device, such as a network computing device, an application server, or a personal computing device. Additionally, or alternatively, one or more process blocks of FIG. 8 may be performed by one or more components of device 500, such as processor 520, memory 530, storage component 540, input component 550, output component 560, and/or communication component 570.

As shown in FIG. 8, process 800 may include generating a first layer of a hierarchical workflow comprising a first set of services of the hierarchical workflow (block 810). For example, the system of one or more computing devices may generate a first layer of a hierarchical workflow comprising a first set of services of the hierarchical workflow, as described above.

As further shown in FIG. 8, process 800 may include generating a second layer of a hierarchical workflow comprising a second set of services of the hierarchical workflow, the second set of services being dependent on one or more services of the first set of services (block 820). For example, the system of one or more computing devices may generate a second layer of a hierarchical workflow comprising a second set of services of the hierarchical workflow, the second set of services being dependent on one or more services of the first set of services, as described above.

As further shown in FIG. 8, process 800 may include generating a third layer of a hierarchical workflow comprising a third set of services of the hierarchical workflow, the third set of services being dependent on one or more services of the second set of services, wherein, based at least in part on error detection at a layer of the hierarchical workflow, the system is configured to re-perform operations associated with the layer having the error without first re-performing operations associated with a previous layer (block 830). For example, the system of one or more computing devices may generate a third layer of a hierarchical workflow comprising a third set of services of the hierarchical workflow, the third set of services being dependent on one or more services of the second set of services, wherein, based at least in part on error detection at a layer of the hierarchical workflow, the system is configured to re-perform operations associated with the layer having the error without first re-performing operations associated with a previous layer, as described above. In some implementations, the first layer is configured to perform one or more operations associated with the first set of services based at least in part on an input and to provide an indication of a first state of the first layer to the second layer. In some implementations, the second layer is configured to perform one or more operations associated with the second set of services based at least in part on the first state of the first layer and provide an indication of a second state of the second layer to the third layer. In some implementations, the third layer is configured to perform one or more operations associated with the third set of services based at least in part on the second state of the second layer and provide an indication of a second state of the second layer to the third layer.

Process 800 may include additional implementations, such as any single implementation or any combination of implementations described below and/or in connection with one or more other processes described elsewhere herein.

In a first implementation, one or more of the indication of the first state or the indication of the second state comprise a computer-based indication without a natural language indication.

In a second implementation, alone or in combination with the first implementation, the first state indicates completion of operations associated with the first set of services, or wherein the second state indicates completion of operations associated with the second set of services.

In a third implementation, alone or in combination with one or more of the first and second implementations, process 800 includes receiving an input from a user, and providing an output to the first layer via a large language module.

In a fourth implementation, alone or in combination with one or more of the first through third implementations, process 800 includes grouping the first set of services into one or more first independent agents of the agent workflow, grouping the second set of services into one or more second independent agents of the agent workflow, and grouping the third set of services into one or more third independent agents of the agent workflow, wherein the error detection comprises identification of an erroneous agent within a layer of the hierarchical workflow.

In a fifth implementation, alone or in combination with one or more of the first through fourth implementations, process 800 includes performing an initial identification of the first set of services and to revise the first set of services using a large language model, planning, and reflection.

Although FIG. 8 shows example blocks of process 800, in some implementations, process 800 may include additional blocks, fewer blocks, different blocks, or differently arranged blocks than those depicted in FIG. 8. Additionally, or alternatively, two or more of the blocks of process 800 may be performed in parallel.

In addition to the implementations described above, elements described in connection with any of processes 600, 700, or 800 may be combined with elements of another of processes 600, 700, or 800.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code - it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A method comprising:
generating a first layer of a hierarchical workflow;
generating a second layer of a hierarchical workflow configured to:
receive a first output from the first layer as an indication of a first state of the first layer;
provide an indication of an error associated with the first output; and
receive a second output, as an indication of a second state of the first layer, from the first layer, the second output being revised from the first output based at least in part on the indication of the error or the second output being the same as the first output after correcting performance of one or more operations at the first layer.

2. The method of claim 1, wherein the first state is selected from a finite quantity of selectable states.

3. The method of claim 1, wherein generating the first layer of the hierarchical workflow and the second layer of the hierarchical workflow comprises:
identifying a first set of services of the hierarchical workflow;
identifying a second set of services of the hierarchical that are dependent on at least one of the first set of services;
assigning the first set of services to the first layer; and
assigning the second set of services to the second layer.

4. The method of claim 3, wherein the first set of services are not dependent on the second set of services.

5. The method of claim 3, comprising:
grouping one or more first services of the first set of services into a first agent of the first layer;
grouping one or more second services of the first set of services into a second agent of the first layer;
grouping one or more third services of the second set of services into a third agent of the second layer,
wherein agents are configured as independent logical nodes that can perform discrete operations and can be independently identified for errors.

6. The method of claim 5, comprising:
performing a large language model operation, planning, and reflection to perform the groupings.

7. The method of claim 3, comprising:
performing a large language model operation, planning, and reflections to assign the first set of services to the first layer and to assign the second set of services to the second layer.

8. The method of claim 1, wherein the first layer of the hierarchical workflow is configured to provide an indication of the first state to a task memory pool,
wherein a previous layer of the hierarchical workflow is configured to provide an indication of a third state, associated with a state of the previous layer to the task memory pool,
wherein the first layer is configured to receive the indication of the third state as an input to correct performance of the one or more operations of the first layer or provide the second output.

9. The method of claim 8, wherein receiving the second output from the first layer comprises:
receiving the second output from the first layer without performing operations at the previous layer after providing the indication of the error associated with the first output.

10. The method of claim 1, wherein receiving the first output and receiving the second output comprises:
receiving the first output and the second output in a computer-based language.

11. A computer program product comprising:
one or more computer readable storage media, and program instructions collectively stored on the one or more computer readable storage media, the program instructions comprising:
program instructions to identify logical execution sequences of services of an agent workflow;
program instructions to identify a first set of the services upon which a second set of services depend;
program instructions to assign the first set of services to a first layer of the agent workflow;
program instructions to assign the second set of services to a second layer of the agent workflow; and
program instructions to provide, from the first layer to the second layer, an indication of a state of the first layer in a computer-based language.

12. The computer program product of claim 11, wherein providing the indication of the state of the first layer in the computer-based language comprises:
refraining from providing the indication of the state of the first layer in natural language.

13. The computer program product of claim 11, wherein the program instructions comprise:
program instructions to group the first set of services into one or more first independent agents of the agent workflow,
program instructions to group the second set of services into one or more second independent agents of the agent workflow, and
program instructions to identify errors within the agent workflow at an agent granularity.

14. The computer program product of claim 11, wherein, to identify the first set of services, the program instructions comprise:
program instructions to use a large language model, planning, and reflection to perform an initial identification of the first set of services and to revise the first set of services.

15. A system comprising:
one or more devices configured to:
generate a first layer of a hierarchical workflow comprising a first set of services of the hierarchical workflow;
generate a second layer of a hierarchical workflow comprising a second set of services of the hierarchical workflow, the second set of services being dependent on one or more services of the first set of services; and
generate a third layer of a hierarchical workflow comprising a third set of services of the hierarchical workflow, the third set of services being dependent on one or more services of the second set of services,
wherein the first layer is configured to perform one or more operations associated with the first set of services based at least in part on an input and to provide an indication of a first state of the first layer to the second layer,
wherein the second layer is configured to perform one or more operations associated with the second set of services based at least in part on the first state of the first layer and provide an indication of a second state of the second layer to the third layer,
wherein the third layer is configured to perform one or more operations associated with the third set of services based at least in part on the second state of the second layer and provide an indication of a second state of the second layer to the third layer, and
wherein, based at least in part on error detection at a layer of the hierarchical workflow, the system is configured to re-perform operations associated with the layer having the error without first re-performing operations associated with a previous layer.

16. The system of claim 15, wherein one or more of the indication of the first state or the indication of the second state comprise:
a computer-based indication without a natural language indication.

17. The system of claim 15, wherein the first state indicates completion of operations associated with the first set of services, or
wherein the second state indicates completion of operations associated with the second set of services.

18. The system of claim 15, wherein the one or more devices are configured to:
receive an input from a user; and
provide an output to the first layer via a large language module.

19. The system of claim 15, wherein the one or more devices are configured to:
group the first set of services into one or more first independent agents of an agent workflow;
group the second set of services into one or more second independent agents of the agent workflow; and
group the third set of services into one or more third independent agents of the agent workflow,
wherein the error detection comprises identification of an erroneous agent within a layer of the hierarchical workflow.

20. The system of claim 15, wherein the one or more devices are configured to:
perform an initial identification of the first set of services and to revise the first set of services using a large language model, planning, and reflection.
